(19) United States
(12) Patent Application Publication
(10) Pub. No.: US 2002/0095648 A1
(43) Pub. Date: Jul. 18, 2002

(54) Layout method of analog/digital mixed semiconductor integrated circuit

(76) Inventor: Tatsuhito Saito, Kanagawa (JP)

Correspondence Address: ROSENMAN & COLIN LLP, 575 MADISON AVENUE, NEW YORK, NY, 10022-2585, US

(21) Appl. No.: 10/037,373

(22) Filed: Oct. 24, 2001

(30) Foreign Application Priority Data
Oct. 25, 2000 (JP) 325648/2000

(51) Int. Cl. G06F 17/50

(52) U.S. Cl. 716/10

(57) ABSTRACT

A layout method of an analog/digital mixed semiconductor integrated circuit of the present invention has the steps of: quantitatively calculating a noise circulation amount with parameters of distances between an analog element, a digital element, and a substrate contact dedicated terminal for the digital element; calculating an optimal layout position of the substrate contact dedicated terminal from a position where the noise circulation amount is smallest; and placing the contact dedicated terminal in the optimal calculated layout position and in the layoutable position.

### BACKGROUND OF THE INVENTION

1. Field of the Invention

The present invention relates to a layout method of an analog/digital mixed semiconductor integrated circuit.

2. Description of the Prior Art

In general, when producing a mixed type LSI having analog circuits anddigital circuitsmixedina semiconductor integrated circuit device, noise caused by the digital circuits affects the analog circuits through the substrate of the LSI. A method for reducing such digital noise or substrate noise has been studied.

In the mixed type LSI having analog circuits and digital circuits mixed, when the operations of a digital element are switched, due to the presence of the time that an N channel transistor and a P channel transistor are turned on at the same time, a passing electric current is flowed from a digital power source to a digital GND, which becomes a noise source to an analog element. In a SUB (substrate, p well)— GND common digital element, the passing electric current is directly flowed into the substrate of the LSI, which is then circulated into an analog region through the substrate.

FIGS. 9 and 10 respectively show circuit diagrams of CMOS inverters constructed by a p channel MOS transistor and an n channel MOS transistor. The CMOS inverter inverts an input signal from an input terminal 51 and outputs the inverted signal from an output terminal 52. A power source is supplied between a power source terminal 53 and a ground terminal 56. As shown in FIG. 9, in an inverter circuit 58, a third terminal 54 and a fourth terminal 55 of the n channel MOS transistor have been connected inside the inverter circuit 58 and been outputted as the ground terminal 56. In this connection, however, digital noise is generally caused in the third terminal 54 together with the operating electric current of the CMOS inverter, which is then directly transmitted to the fourth terminal 55. As a result, the noise is given to the substrate voltage of the chip. To reduce the substrate noise, the fourth terminal 55 of the n channel MOS transistor must be isolated so as to prevent the influence of the noise. As shown in FIG. 10, it is typically known that when the fourth terminal 55 as a substrate contact terminal 57 is outputted outside of the chip and a stable voltage is directly applied from the outside to the substrate, this is effective for reducing the substrate noise. A technique for providing the substrate contact dedicated connecting terminal (hereinafter, called a SUB pin) 57 is disclosedin Japanese Published Unexamined patent application No. Hei 7-193189 (a known document).

On the other hand, ina SUB-GND isolating digital element, when the digital element is operated at a low frequency, noise is hardly circulated into the substrate. When the digital element is operated at a high frequency, a passing electric current is flowed into the substrate through a parasitic capacitance between the digital element gate polysilicon and the substrate, which is then circulated into an analog region through the substrate.

To prevent noise circulation, there has been typically performed a method in which an N well, a guard ring, a P+ subcomponent and the like are placed between a digital region and an analog region so as to isolate an analog power source from a digital power source. The N well guard ring reduces noise circulation through the substrate by isolating the analog region and the digital region of the LSI substrate. The well guard ring generally biases the LSI substrate at the power source potential with low noise and low impedance. The P+ subcomponent guard ring biases the LSI substrate at the GND potential with low noise and low impedance. The noise component of the substrate is suppressed.

To reduce the LSI cost, it has been recently required that large-scale, high-frequency operating digital circuits and high-precision analog circuits are mixed on one chip. To meet this demand, noise circulation from the large-scale, high-frequency operating digital element to the high-precision analog element must be reduced as compared with the prior art.

For example, as disclosed in the above-mentioned Japanese Published Unexamined Patent Application No. Hei 7-193189, there is proposed an analog/digital mixed LSI constructed by SUB— GND (substrate contact dedicated power source wiring) common core circuits, SUB— GND isolating digital circuits and analog circuits, wherein the core circuit, the SUB isolating digital circuit, and the analog circuit are placed in that order so as to reduce the influence of noise.

A layout example applying a method disclosed in the known document is shown in the plan view of FIG. 11. FIG. 11 shows a construction provided with a SUB-GND unisolating digital circuit region 39, a SUB-GND isolating digital circuit region 40, and ananalog circuit region 41. The construction has a feature such that the SUB-GND common digital circuit region 39 and the analog circuit region 41 are isolated from each other by the SUB-GND isolating digital circuit region 40.

With the construction of FIG. 11, noise circulation from the SUB-GND unisolating digital circuit region 39 having a large amount of noise of the substrate to the analog circuit region 41 can be reduced by isolating the regions 39 and 41 by the SUB-GND isolating digital circuit region 40.

FIG. 12 shows a flowchart of assistance in explaining the process of the known document. First, in step S11 (S1), requirements are inputted. Then, in step S12, a floor plan of an analog region and a digital region is studied from the requirements so as to decide the floor plan of the analog region and the digital region. In step S13, a floor plan of the SUB -GND isolating digital region 40 and the SUB-GND common digital region 39 is studied and the analog region 41 is placed so as to be surrounded by the SUB-GND isolating digital region 40, whereby the SUB-GND common digital region 40 is placed in the remaining region. In step S14, a measure to reduce noise circulated from the digital element to the analog element is studied, and pin layout is decided. In step S14 (S9), a layout design 46 is performed.

In the prior art described above, studying of the SUB pin layout position is not included in the flow of FIG. 12 and is performed intuitively. However, noise caused in all the digital elements is concentrated in the vicinity of the digital element SUB pins. The noise component density of the substrate in the vicinity of the SUB pins is increased. When the digital element SUB pins are placed in the vicinity of the analog circuit, noise caused in the digital circuit is circulated into the analog element through the substrate.

### BRIEF SUMMARY OF THE INVENTION

Objects of the Invention

An object of the present invention is to provide a layout method of an analog/digital mixed semiconductor integrated circuit device for deciding optimal digital SUB pin layout positions so that an amount of noise circulated from a digital element to an analog element is smallest.

### SUMMARY OF THE INVENTION

A layout method of the analog/digital mixed semiconductor integrated circuit according to the present invention having the steps of: quantitatively calculating a noise circulation amount with parameters of distances between an analog element, a digital element, and a substrate contact dedicated terminal for the digital element; calculating an optimal layout position of the substrate contact dedicated terminal from a position where the noise circulation amount is smallest; and placing the contact dedicated terminal in the optimal calculated layout position and in the layoutable position.

### BRIEF DESCRIPTION OF THE DRAWINGS

The above-mentioned and other objects, features and advantages of this invention will become more apparent by reference to the following detailed description of the invention taken in conjunction with the accompanying drawings, wherein:

FIG. 1 is a flowchart of assistance in explaining a noise preventing method of one embodiment of the present invention;

FIG. 2 is a block diagram showing the layout of an applied semiconductor device of FIG. 1;

FIG. 3 is an equivalent circuit diagram of FIG. 2;

FIG. 4 is a graph of noise circulation amounts of assistance in explaining the effect of FIG. 1;

FIG. 5 is a flowchart of assistance in explaining another embodiment of the present invention;

FIG. 6 is a layout showing the placement of another embodiment of the present invention;

FIG. 7 is a layout showing the placement of a further embodiment of the present invention;

FIG. 8 is a layout showing the placement of still another embodiment of the present invention;

FIG. 9 is a circuit diagram of an inverter having a substrate contact dedicated connecting terminal;

FIG. 10 is a circuit diagram of an inverter not having the substrate contact dedicated connecting terminal;

FIG. 11 is a layout showing the placement of a prior art semiconductor device; and

FIG. 12 is a flowchart showing the steps of a prior art noise preventing method.

### DETAILED DESCRIPTION OF THE INVENTION

Embodiments of the present invention will be described with reference to the drawings.

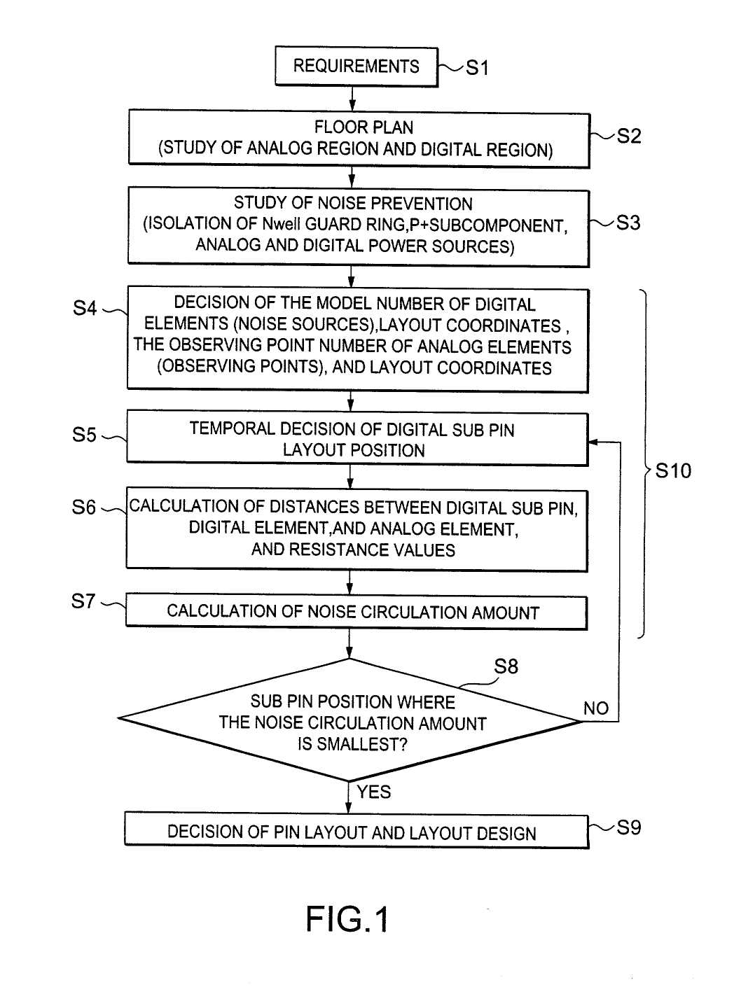

FIG. 1 is a flowchart of a noise preventing method of assistance in explaining one embodiment of the present invention. In a method for deciding a SUB pin position where a noise circulation amount is smallest according to this embodiment, requirements are first decided in step S1, an analog region and a digital region are studied in step S2, and noise prevention is studied in step S3.

In step S4, the layout position of one or more digital elements as noise source and the layout position of one or more analog elements as observing points are set in typical layout coordinates based on the floor plan. In step S5, a digital SUB pin layout positions is decided temporarily. In step S6, distances between the respective elements are calculated from the digital SUB pin layout coordinates, the digital element layout coordinates, and the analog element layout coordinates. In step S7, wiring resistances and substrate resistances are calculated from the calculated distances so as to be reflected on the noise circulation model circuit, there by calculating noise circulation amounts. The steps from temporal decision of the digital SUB pin layout position (step S5) to calculation of the noise circulation amounts (step S7) are performed by a combination of all the digital SUB pin layout positions. In step S8, adigital SUB pin position where the noise circulation amount is smallest is decided. In the case that the digital SUB pin is not in the position where the noise circulation amount is smallest, the routine is returned to step S5. In the case that the digital SUB pin is in the position where the noise circulation amount is smallest, the routine is advanced to step S9. These steps S4 to S8 become a digital SUB pin layout position deciding step S10.

Referring to FIG. 1, based on requirements 1 of step S1, the layout positions of the analog region and the digital region in the LSI layout are studied with the floor plan in step S2. When a digital block is constructed by both a SUB-GND isolating block and a SUB-GND common block, the layout positions of the SUB-GND isolating block and the SUB-GND common block are studied separately.

In noise prevention of step S3, to prevent noise caused in the digital element from being circulated into the analog element through the substrate, the N well and the P+ subcomponent guard rings are placed between the analog region and the digital region.

The digital SUB pin layout position deciding method is shown in step S10 of FIG. 1. In step S4, based on the floor plan of step S2, modeling of the digital element as noise source and modeling of the analog element susceptible to noise are performed. The modeling method studies the model number of the digital elements. When the model number is increased, the calculation error is reduced. The shape of the digital region is divided into the lowest number of rectangles. Modeling maybe performed to only the number of rectangles. The modeling number of the analog elements is decided as in the digital elements. The coordinate position of the center of gravity dividing the region is the coordinate position of the modeling elements. In the temporal decision of the digital SUB pin layout position of step S5, the digital SUB pin layout position is decided temporarily in any pin coordinate position of the chip side.

In step S6, a distance between the digital element and the analog element modeled in step S4, a distance between the digital element and the digital SUB pin, and a distance between the analog element and the digital SUB pin are calculated. Resistance values are calculated from the calculated distances. A path in which noise is circulated from the digital element to the analog element is shown by resistance and capacitance circuits. In calculation of the noise circulation amount in step S7, a circuit transmission function determined in step S6 is solved so as to calculate a noise amount circulated from the digital element to the analog element. In step S8, the noise circulation amounts are compared, the temporal decision of the digital SUB pin layout position of step S5 to the calculation of the noise circulation amount of step S7 are repeated so as to determine a digital SUB pin layout position where a noise amount circulated from the digital element to the analog element is smallest. In step S9, a layout design is performed in the digital SUB pin layout position determined in step S8.

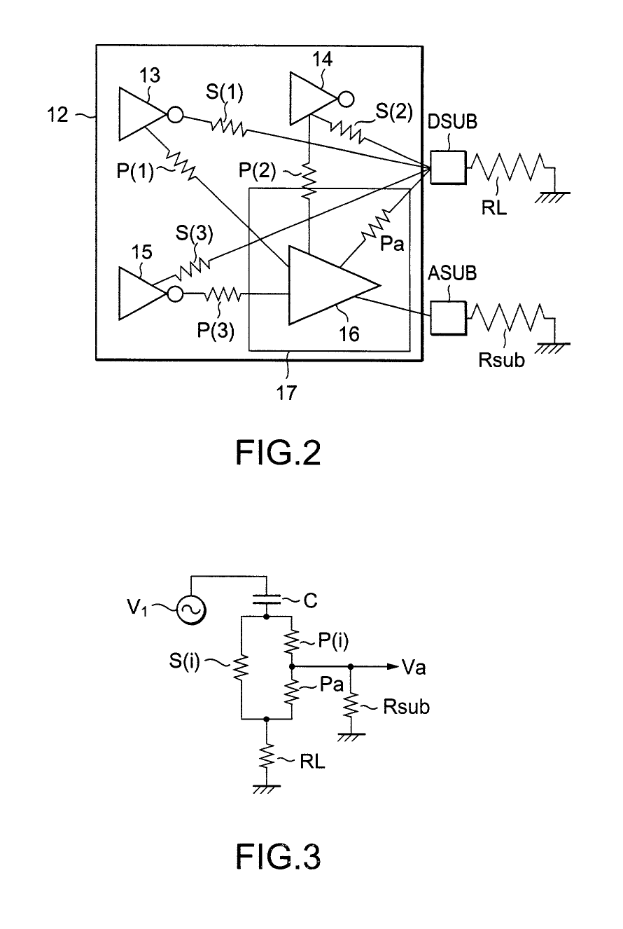

FIG. 2 is a circuit block diagram showing a specific example of the noise preventing method of step S3. A chip 12 has an analog region 17 and digital regions in other regions. From the shape of the digital region, digital elements 13 to 15 with the modeling number of 3 are placed in coordinates (13, 14 and 15). From the shape of the analog region, the analog element 16 with the modeling number of 1 is placed in a coordinate (16).

In an LSI construction having a digital element SUB pin DSUB and an analog SUB pin ASUB, there are estimated parasitic capacitances of wiring resistances S1, S2 and S3 from the digital element to the digital element SUB pin DSUB, substrate resistances P1, P2 and P3 from the digital element to the analog element 16, substrate resistance Pa from the analog element 16 to the digital element SUB pin DSUB, DSUB wiring resistance RL outside the chip such as wiring of the substrate assembled with a bonding wire and the chip, and ASUB wiring resistance Rsub outside the chip.

FIG. 3 is a circuit diagram showing FIG. 2 with the capacitance, the resistance and the power source. For simplification, the construction of one digital element is shown here. In FIG. 3, the construction is provided with noise source Vi caused in the digital element, coupling capacitance C of the transistor gate constructing the digital element and the substrate, wiring resistance Si from the digital element to the DSUB pin, substrate resistance Pi from the digital element to the analog element, substrate resistance Pa from the analog element to the DSUB pin, DSUB wiring resistance RL outside the chip, and analog (ASUB) wiring resistance Rsub outside the chip.

Assume that there are digital and analog element models as shown in FIG. 2. In accordance with step S5 of FIG. 1, digital element layout coordinates are (xi, yi), analog element layout coordinates are (xa, ya), and SUB pin layout coordinates are (xs, ys) . In accordance with step S6 of FIG. 1, the digital SUB pin is placed temporarily in the DSUB position of FIG. 2. Then, in accordance with step S7 of FIG. 1, distances between the digital SUB pin, the analog element, and the digital element are calculated so as to determine resistance values S1, S2, S3, P1, P2, P3 and Pa.

In all the SUB-GND isolating digital elements 13, 14 and 15, the operating frequency is f[Hz], the parasitic capacitance between the gate polysilicon and the substrate is C[F], and noise caused in the digital element is Vi. The modeling number of the digital elements is n, the total number of the digital elements on one chip is T, and the path in which noise is circulated from the digital element to the analog element is only through the substrate. From the above-mentioned conditions, in accordance with step S7 of FIG. 1, substrate noise Va circulated to the analog element is calculated by the following equation (1).

$$Va = {\sum }_{i = 1}^{n} [ \frac{Rsub}{Rsub + \frac{1}{[ \frac{Si \cdot Pi}{Si \cdot RL + Si \cdot Pa + Pi \cdot RL + Pa \cdot RL} + 1 ]}} \cdot 2 π fC \cdot {V}_{3} ] \cdot \frac{T}{n} \qquad ( 1 )$$

At this time, the noise amount Va circulatedinto the analog circuit is expressed in the following equation (2).

$$\begin{matrix}Si = \sqrt{{( xi - xs )}^{2} + {( yi - ys )}^{2} \cdot β} \\ Pi = \sqrt{{( xi - xa )}^{2} + {( yi - ya )}^{2} \cdot α} \\ Pa = \sqrt{{( xa - xs )}^{2} + {( ya - ys )}^{2} \cdot α}\end{matrix} \} \qquad ( 2 )$$

As apparent from the equations (1) and (2), distance S1 from the SUB pin to the digital element is small, and distance Pa from the digital SUB pin to the analog element is large. The noise circulation can be thus reduced.

As a specific example, α is 0.2Ω/mm, β is 10Ω/mm, RSUB and RL are 0.06Ω, f is 60MHz, C is 0.002pF, T is 300000 pieces, and one side of the square chip is 7mm.

As shown in the layout ofFIG. 4, the chip center coordinates are (0mm, 0mm), the analog element 16 coordinates are (2.5mm, 2mm), the digital element 14 coordinates are (2.5mm, −0.5mm), the digital element 13 coordinates are (−1.5mm, −0.5mm), and the digital element 15 coordinates are (−1.5mm, 2mm), thereby calculating noise circulation amount Va.

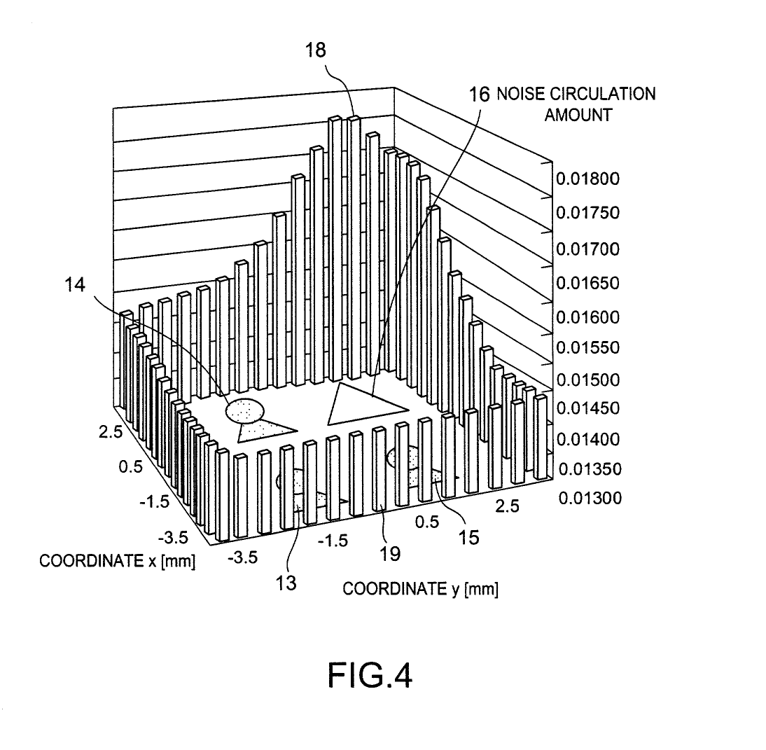

The graph of FIG. 4 shows the results in which the noise circulation amounts are calculated in the case that the digital SUB pins are placed in all the pin layout positions. The graph of FIG. 4 shows the noise amounts circulated into the analog block corresponding to the coordinates to place the DSUB. The noise circulation amount caused the digital element 16 is −29.5dB (0.0175) in the SUB pin layout position 18 where the noise circulation amount is largest. The noise circulation amount caused the digital element 16 is −35.7dB (0.0140) in the SUB pin layout position 19 where the noise circulation amount is smallest. Using this embodiment, improvement of 6dB noise can be realized. A pin position 19 where the noise circulation amount of FIG. 4 is smallest is an optimal digital SUB pin layout position.

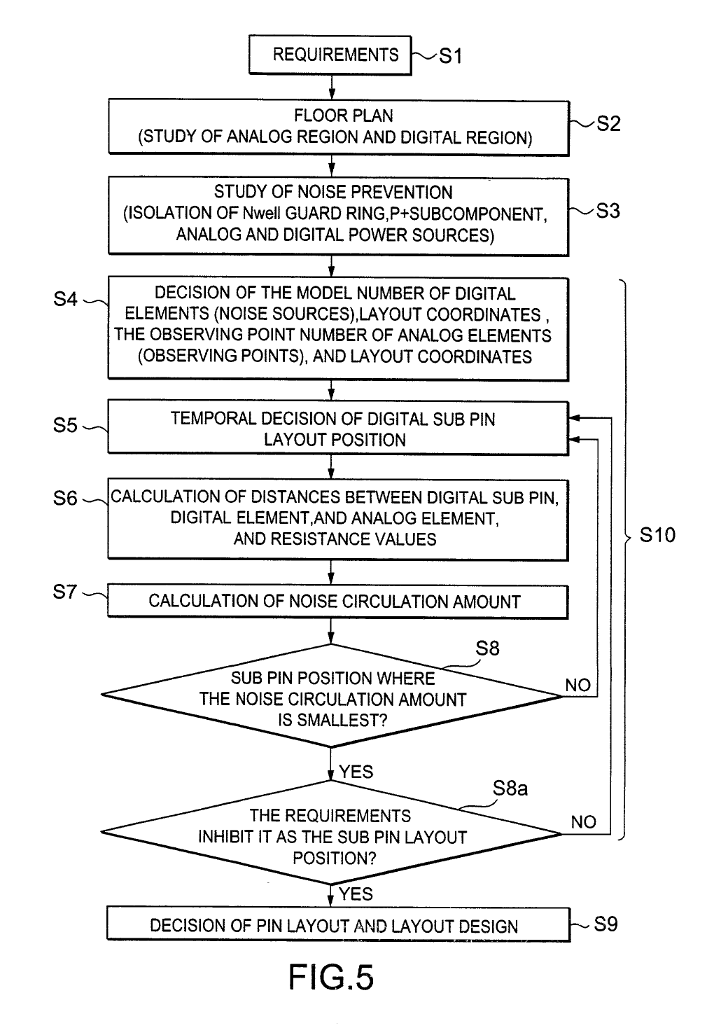

FIG. 5 is a flowchart of assistance in explaining another embodiment of the present invention. FIG. 5 shows a flow in the case that the pin layout position limitation is indicated in the requirements of step S1. When the layout position of pins other than DSUB or the pin layout order is specified in the requirements of step S1, the DSUB pin cannot be placed in the position optimal for noise circulation.

Steps S1 to S8 of FIG. 5 are the same as the flow explained in FIG. 1, and the explanation thereof is omitted. In this embodiment, step S8a is added after step S8 of FIG. 5. In step S8a, whether the optimal DSUB pin satisfies the pin layout position limitation of the requirements or not is judged. In the case that the DSUB pin cannot be placed due to the pin layout position limitation, the position is excluded, and then, the routine is returned to step S5. In this case, a flow to set another optimal layout position is provided.

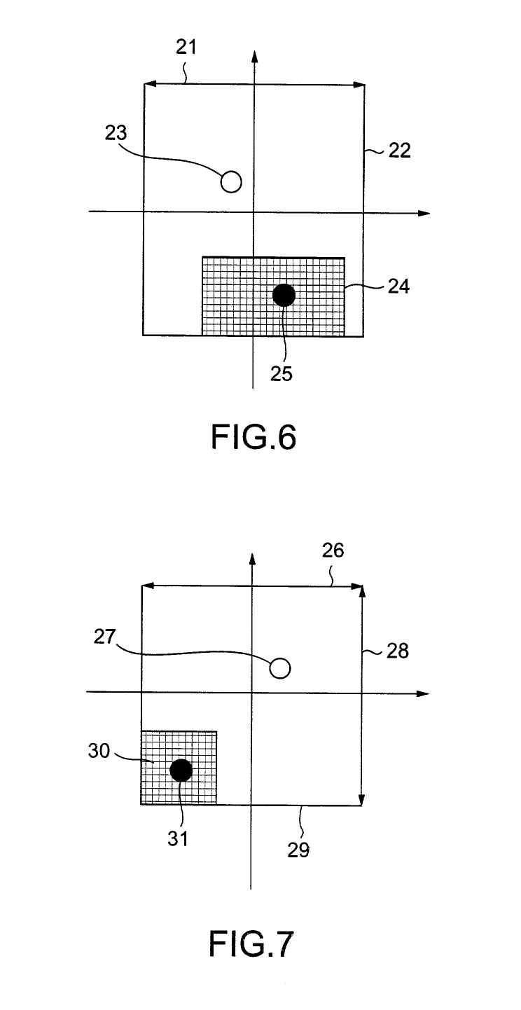

FIG. 6 is a plan view of an IC chip of assistance in explaining another embodiment of the present invention. In FIG. 6, a digital region 22 has a center of gravity 23 of the digital region (the center point of the region 22 in the case of the plane), and an analog region 24 has a center of gravity 25 of the analog region. Here, assume that modeling is not performed by the limited model number of the digital elements and the analog elements, and the digital elements are distributed uniformly in the digital region 22 and the analog elements are also distributed uniformly in the analog region 24. From the equations (1) and (2), the digital SUB pin is placed in a side 21 farthest from the center of gravity 25 of the analog region so as to reduce the noise circulation amount. The digital SUB pin is placed in the side 21 closest to the center of gravity 23 of the digital region so as to minimize the noise circulation amount.

FIG. 7 is also a plan view of an IC chip of assistance in explaining a further embodiment of the present invention. In this case, there are two sides farthest froma center of gravity 31 of an analog region 30, and the analog region 30 is present in a digital region 29 having a center of gravity 27. When the digital SUB pin is either pin positions 26 and 28 of FIG. 7, the noise circulation amounts are the same.

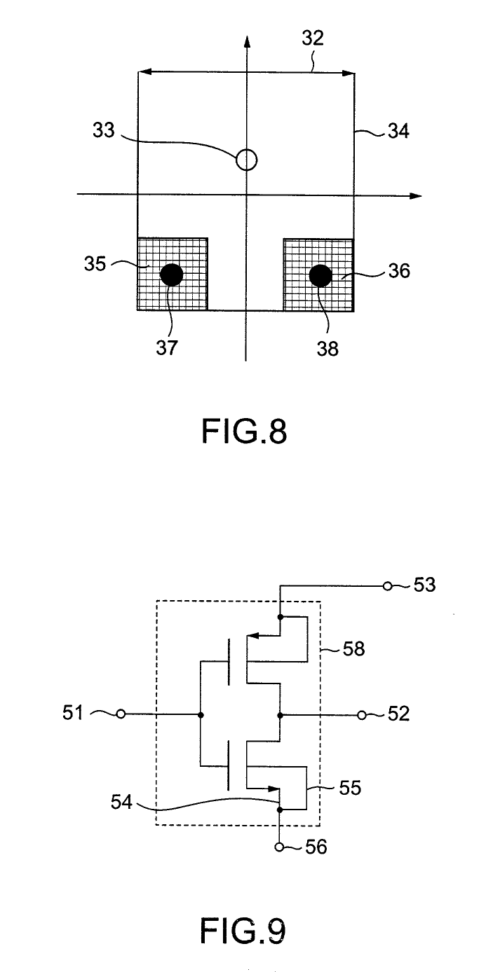

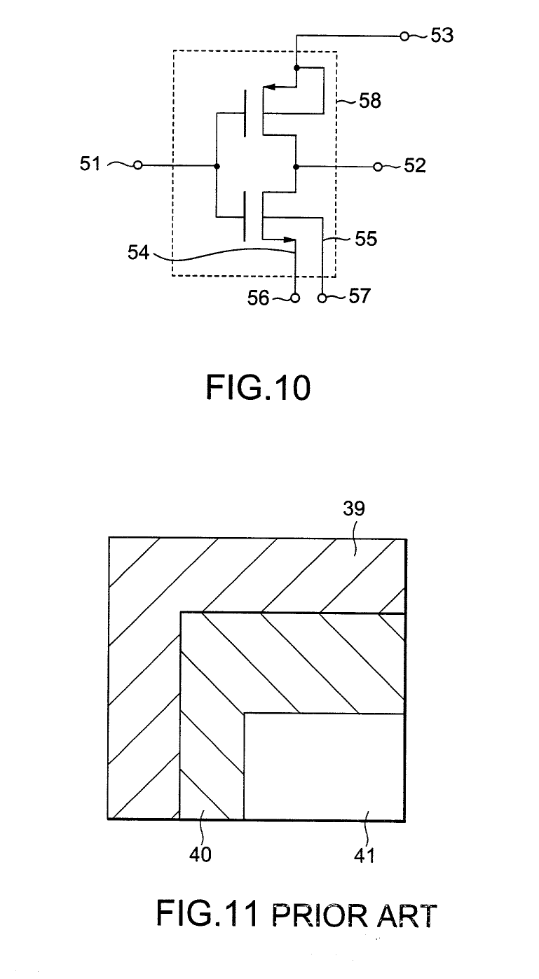

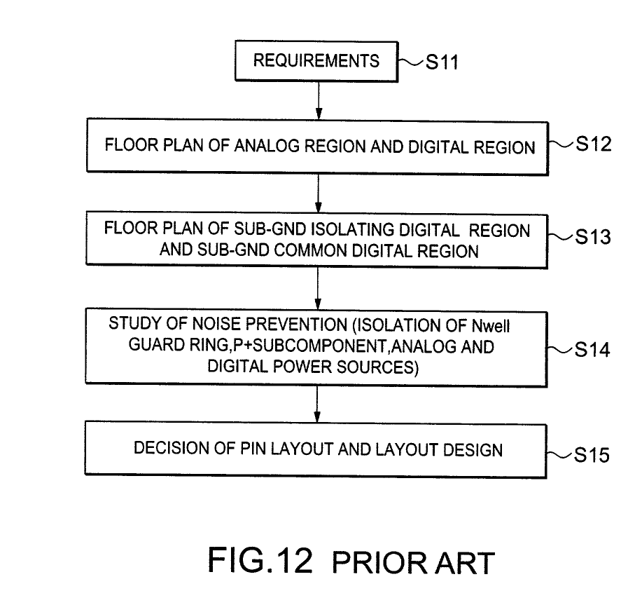

FIG. 8 is a plan view of an IC chip of assistance in explaining still another embodiment of the present invention. This case is an example in which the analog regions are placed separately in two or more positions, and analog regions 35 and 36 are placed in a digital region 34 having a center of gravity 33. Also in this case, the digital SUB pin is placed in a SUB pin layout position 32 on a side farthest fromcenters of gravity 37 and 38 of the analog regions 35 and 36 so as to minimize the noise circulation amount.

As described above, the present invention can provide a semiconductor integrated circuit which can decide an optimal digital SUB pin layout position so that a noise circulation amount from a digital element to an analog element is smallest and can minimize this kind of noise circulation amount.

Although the invention has been described with reference to specific embodiments, this description is not meant to be construed in a limiting sense. Various modifications of the disclosed embodiments will become apparent to persons skilled in the art upon reference to the description of the invention. It is therefore contemplated that the appended claims will cover any modifications or embodiments as fall within the true scope of the invention.

What is claimed is:

1. A layout method of ananalog/digital mixed semiconductor integrated circuit comprising the steps of: quantitatively calculating a noise circulation amount with parameters of distances between an analog element, a digital element, and a substrate contact dedicated terminal for the digital element; calculating an optimal layout position of said substrate contact dedicated terminal from a position where said noise circulation amount is smallest; and placing said contact dedicated terminal in said optimal calculated layout position and in the layoutable position.

2. A layout method of an analog/digital mixed semiconductor integrated circuit comprising the steps of: calculating distances between the modeled digital element, analog element, and the substrate contact dedicated terminal for the digital element and resistances corresponding to the distances so as to create a circuit model of a noise circulation path between the element and the terminal from the respective resistance values, thereby determining noise circulation amounts; calculating an optimal layout position of said substrate contact dedicated terminal from the position where said noise circulation amount is smallest; and placing said contact dedicated terminal in said optimal calculated layout position and in the layoutable position.

3. A layout method of an analog/digital mixed semiconductor integrated circuit comprising: a first step for deciding requirements to a circuit; a second step for studying a floor plan of an analog region and a digital region; a third step for studying noise prevention; a fourth step for setting the layout position of one or more digital elements as noise source and the layout position of one or more analog elements as observing points in typical layout coordinates based on said floor plan; a fifth step for temporarily deciding the layout position of the substrate contact dedicated terminal for the digital element on said floor plan; a sixth step for calculating distances between said elements from the layout coordinates of said substrate contact dedicated terminal for the digital element, the layout coordinates of said digital element, and the layout coordinates of said analog element; a seventh step for calculating wiring resistance and substrate resistance from said calculated distances so as to be reflected on a noise circulation model circuit, thereby calculating the noise circulation amount; and an eighth step for performing the steps 1 to 7 by a combination of the layout positions of all said substrate contact dedicated terminals for the digital element and deciding and layouting the position of the substrate contact dedicated terminal for the digital element where said noise circulation amount is smallest.

4. The layout method of a semiconductor integrated circuit according to claim 3, further comprising, after said step 8, a step for judging whether the optimal substrate contact dedicated terminal for the digital element satisfies the pin layout position limitation of the requirements or not, excluding the pin layout position in the case that said substrate contact dedicated terminal for the digital element cannot be placed due to the pin layout position limitation, and selecting the pin layout position meeting the requirements.
